(19) United States
(12) Patent Application Publication
(10) Pub. No.: US 2024/0106090 A1
(43) Pub. Date: Mar. 28, 2024

(54) EMBEDDED ELECTRODE FORMATION INCLUDING SYMMETRICALLY SLIT ELECTRODES

(71) Applicant: Apple Inc., Cupertino, CA (US)

(72) Inventors: Jinjun Shi, San Jose, CA (US); Ghazal Shoorideh, Santa Clara, CA (US); Liang Guo, San Jose, CA (US); Lin Ma, Santa Clara, CA (US); Premanand Ramadass, San Mateo, CA (US); Rui Guo, Cupertino, CA (US); Yao Lu, San Jose, CA (US)

(21) Appl. No.: 18/186,787

(22) Filed: Mar. 20, 2023

Related U.S. Application Data
(60) Provisional application No. 63/408,958, filed on Sep. 22, 2022.

(51) Int. Cl. H01M 50/538; H01M 50/536

(52) U.S. Cl. CPC H01M 50/538; H01M 50/536

(57) ABSTRACT

An electrode cell manufacturing process may include forming an electrode sheet including an electrode material and an active material. A first plurality of electrode tab windows may be defined in the active material to expose first portions of the electrode material. The process may also include slitting the electrode sheet along a first line that orthogonally intersects the first plurality of electrode tab windows to define a first electrode strip including a first set of electrodes and a second electrode strip including a second set of electrodes.

### CROSS-REFERENCE TO RELATED APPLICATION

This application priority to U.S. Provisional Application Ser. No. 63/408,958 filed Sep. 22, 2022 entitled “EMBEDDED ELECTRODE FORMATION INCLUDING SYMMETRICALLY SLIT ELECTRODES,” which is incorporated herein by reference in its entirety.

### BACKGROUND

A battery cell layer may be formed from an active material layer disposed along an electrode material layer. Multiple battery cell layers may be stacked or rolled to define a battery. The battery cell layers may be electrically connected via electrode tabs that are electrically connected to the electrode material layers of each respective battery cell layer.

### BRIEF SUMMARY

One general aspect includes a manufacturing method. The manufacturing method includes forming an electrode sheet including an electrode material and an active material, where a first plurality of electrode tab windows is defined in the active material to expose first portions of the electrode material. The manufacturing method also includes slitting the electrode sheet along a first line that orthogonally intersects the first plurality of electrode tab windows to define a first electrode strip including a first set of electrodes and a second electrode strip including a second set of electrodes.

Another general aspect includes an electrode. The electrode includes an electrode sheet including a first edge and a second edge, where the electrode sheet is formed from an electrode material and an active material. The electrode also includes an electrode defined in the active material to expose a portion of the electrode material, where the electrode extends from the first edge towards the second edge, and where the portion of the electrode material extends across the electrode to the first edge

Another general aspect includes a battery cell. The battery cell includes a first electrode including: a first tab window defined in a first active material layer of the first electrode at a first edge of the first electrode to reveal a portion of a first electrode material layer of the first electrode that extends to the first edge, and a first tab electrically and physically connected to the portion of the first electrode material layer exposed within the first tab window. The battery cell also includes a second electrode including: a second tab window defined in a second active material layer of the second electrode at a second edge of the second electrode to reveal a portion of a second electrode material layer of the second electrode that extends to the second edge, and a second tab electrically and physically connected to the portion of the second electrode material layer exposed within the second tab window.

### BRIEF DESCRIPTION OF THE DRAWINGS

A further understanding of the nature and advantages of the disclosed examples may be realized by reference to the remaining portions of the specification and the drawings.

FIG. 1 depicts a schematic cross-sectional view of materials for an energy storage device or battery cell, according to at least one example.

FIG. 2 shows a perspective view of a battery into which may be incorporated battery cells formed using a process for improved embedded electrode formation, according to at least one example.

FIG. 3 shows a flowchart illustrating a process for improved embedded electrode formation, according to at least one example.

FIG. 4 shows a schematic view of an electrode sheet in accordance with the process from FIG. 3, according to at least one example.

FIG. 5 shows a schematic view of an electrode sheet depicting longitudinal slitting lines that define electrode strips in accordance with the process from FIG. 3, according to at least one example.

FIG. 6 shows a schematic view of a few electrode strips after being slit along longitudinal slitting lines in accordance with the process from FIG. 3, according to at least one example

FIG. 7 shows a schematic view of a few electrode strip parts after being slit along transverse slitting lines in accordance with the process from FIG. 3, according to at least one example.

FIG. 8A shows a schematic top view of an electrode strip part zoomed in on an electrode, according to at least one example.

FIG. 8B shows a schematic side view the electrode strip part and the electrode from FIG. 8A, according to at least one example.

FIG. 8C shows a schematic cross-sectional view of the electrode strip part and the electrode from FIG. 8A taken at section A-A, according to at least one example.

FIG. 9 shows a schematic view of an electrode strip part including an electrode tab disposed within a portion of a tab window that defines an electrode in accordance with the process from FIG. 3, according to at least one example.

FIG. 10 shows a schematic view of an electrode strip part including a tape covering a portion of an electrode in accordance with the process from FIG. 3, according to at least one example.

Several of the figures are included as schematics. It is to be understood that the FIGS. are for illustrative purposes, and are not to be considered of scale or proportion unless specifically stated to be of scale or proportion. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The techniques described herein are directed, among other things, processes relating to embedded electrode formation and electrode cells formed using such processes. Electrode cells, battery cells, and more generally energy storage devices, are used in a host of different systems. In many devices, the battery cells may be designed to be housed within an enclosure such as a rigid can or a pliable composite pouch. Certain battery cells may include embedded electrode tabs that are used to electrically connect the battery cell structure (e.g., layered structure or rolled structure) with contacts extending outside of the enclosure. Such embedded tab designs are common in battery cell manufacturing, especially in lithium-ion cells.

Conventionally, an electrode in a battery cell may include a layer of conductive material covered by an active material. Certain areas of the active material are removed to reveal electrode tab windows. Conventionally, a single electrode sheet is formed that includes the layer of active material and the conductive material. The active material can be cut in different ways to create multiple electrodes. Conventionally, as an initial step, active material may be removed from the electrode sheet to reveal the conductive material. This may define repeating patterns of electrode tab windows. Afterwards, the single sheet may be slit multiple times to define electrode strips that include one or more electrode tab windows. Conventionally, such slitting occurs on lines that run longitudinally across the sheet at positions that are adjacent to the electrode tab windows, but that do not intersect the electrode tab windows. For example, when the electrode tab windows have a rectangular shape, the slitting lines may run directly above (or below) the shorter sides of the rectangles without also intersecting the rectangles.

In this conventional technique, once the slitting operation has been performed, a small amount of active material remains between the slit edge and the shorter distal sides of the electrodes defined within the electrode tab windows. In order to prepare the electrodes for welding, additional steps are performed to remove this remaining active material and to create a clean electrode edge that is ready for welding. This may include a groove cutting step that uses a cutting tool to remove the excess active material between the distal sides of an electrode and the slit edge of the sheet. The groove cutting step may be performed by a laser or other cutting tool that removes the excess active material and also cuts into the conductive material layer, leaving behind a notch-shaped cutout in the conductive material that is about equal to the width of the electrode tabs. In some cases, the groove cutting operation may include peelable coating layer (PCL), blading with solvent, laser cutting and brushing, laser ablation, and other operations suitable for removing small amounts of the electrode sheet.

The technology described herein includes processes relating to embedded electrode formation and electrode cells formed using such processes that overcome the deficiencies of the conventional approaches. This is possible, at least in part, because, rather than laying out repeating patterns of electrode tab windows in a manner that requires slitting to be performed outside of the electrode tab windows, the described technology includes laying out the electrode tab windows in a way that allows slitting to occur across each electrode tab window to define two electrodes from each electrode tab window, rather than just one electrode as is conventional. In this manner, when the slitting does occur, each electrode tab window results in two mirrored electrodes, rather than just one electrode as with the conventional approaches. This results in a 50% reduction in the number of slits needed for a comparable electrode sheet, as compared to conventional approaches. Additionally, because the slitting intersects across the electrode tab windows (rather than adjacent to ends of the electrode tab windows), ends of the active material are exposed as part of the slitting operation, meaning that the additional conventional cleaning/groove cutting operation is not required. The reduction in number of slits and elimination of the groove cutting operation may result in significant operational and throughput gains.

Turning now to a particular example, in this example, there is described a process relating to embedded electrode formation. The process may begin by forming an electrode sheet that is made up of an active material layer disposed along a first surface of a conductive layer. As part of forming the electrode sheet or as a subsequent operation, a set of electrode tab windows may be defined within the electrode sheet. In each electrode tab window, the active material layer has been removed (or patterned so as to not be disposed thereon) from the conductive material, revealing areas of conductive material. These areas may have a rectangular shape and be disposed in a repeating pattern widthwise and lengthwise across the electrode sheet. For example, a first portion of the set of electrode tab regions may define a first row extending widthwise and a second portion of the set of electrode tab windows may define a second row extending widthwise and spaced apart from the first row. The first row may also be spaced part from an edge of the electrode sheet. Slitting operations may be performed along a first slit line that runs orthogonally across the electrode tab windows in the first row, a second slit line that runs orthogonally between the two rows, and a third slit line that runes orthogonally across the electrode tab windows in the second row. The first and third slit lines cut each electrode tab window into two mirrored symmetrical electrodes that are ready for additional transverse slitting, tab welding, and the like.

Although the remaining portions of the description may reference lithium-ion batteries for use in portable electronic devices, it will be readily understood by the skilled artisan that the technology is not so limited. The present techniques may be employed with any number of battery or energy storage devices, including other rechargeable and primary battery types, as well as secondary batteries, or electrochemical capacitors. Moreover, the present technology may be applicable to batteries and energy storage devices used in any number of technologies that may include, without limitation, phones and mobile devices, watches, glasses, bracelets, anklets, and other wearable technology including fitness devices, handheld electronic devices, laptops and other computers, motor vehicles and other transportation equipment, as well as other devices that may benefit from the use of the variously described battery technology.

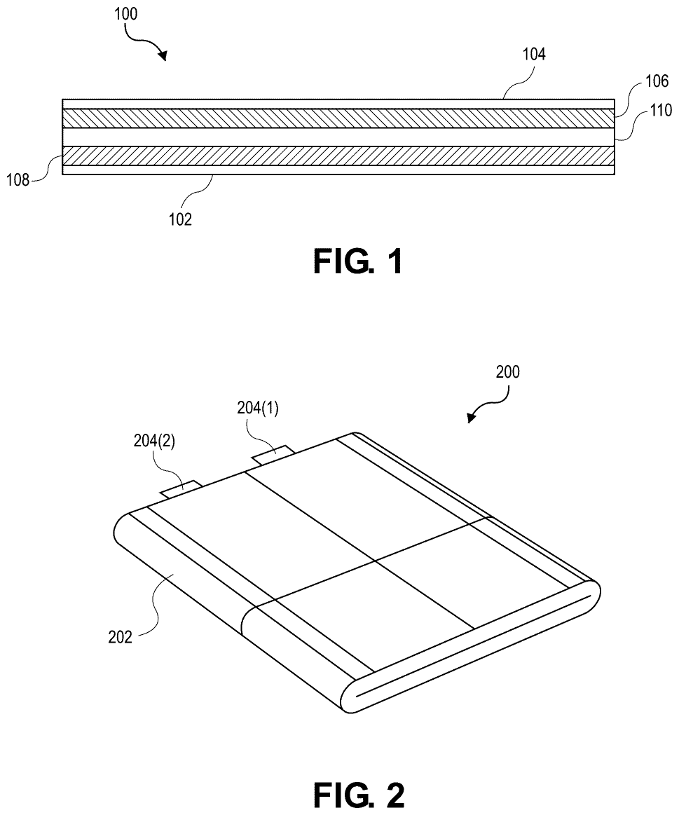

FIG. 1 depicts a schematic cross-sectional view of materials for an energy storage device or battery cell 100, according to at least one example. Battery cell 100 may be or include an electrode stack, and may be one of a number of stacks coupled together to form a battery structure. As would be readily understood, the layers are not shown at any particular scale, and are intended merely to show the possible layers of cell material of one or more cells that may be incorporated into an energy storage device. As shown in FIG. 1, battery cell 100 includes a first current collector 102 and a second current collector 104. In some examples, one or both of the current collectors may include a metal or a non-metal material, such as a polymer or composite that may include a conductive material. The first current collector 102 and second current collector 104 may be different materials in examples. For example, in some examples, the first current collector 102 may be a material selected based on the potential of an anode active material 106, and may be or include copper, stainless steel, or any other suitable metal, as well as a non-metal material including a polymer. The second current collector 104 may be a material selected based on the potential of a cathode active material 108, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 106 may be silicon, graphite, carbon, a tin alloy, lithium metal, a lithium-containing material, such as lithium titanium oxide, or other suitable materials that can form an anode in a battery cell. Additionally, for example, the cathode active material 108 may be a lithium-containing material. In some examples, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other examples the lithium-containing material can be a lithium iron phosphate, or other suitable materials that can form a cathode in a battery cell.

The first and second current collectors as well as the active materials may have any suitable thickness. A separator 110 may be disposed between the electrodes, and may be a polymer film or a material that may allow lithium ions to pass through the structure while not otherwise conducting electricity. Active materials 106 and 108 may additionally include an amount of electrolyte in a completed cell configuration, which may be absorbed within the separator 110 as well. The electrolyte may be a liquid including one or more salt compounds that have been dissolved in one or more solvents. The salt compounds may include lithium-containing salt compounds in examples, and may include one or more lithium salts including, for example, lithium compounds incorporating one or more halogen elements such as fluorine or chlorine, as well as other non-metal elements such as phosphorus, and semimetal elements including boron, for example.

In some examples, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities, such as greater than or about 5⁻¹⁰ mS/cm.

Although illustrated as single layers of electrode material, battery cell 100 may be any number of layers. Although the cell may be composed of one layer each of anode and cathode material as sheets, the layers may also be formed into any form such that any number of layers may be included in battery cell 100. For examples which include multiple layers, tab portions of each anode current collector may be coupled together, as may be tab portions of each cathode current collector, although one or more of the current collectors may be a continuous current collector material as will be described below. Once the cell has been formed, a pouch, housing, or enclosure may be formed about the cell to contain electrolyte and other materials within the cell structure. Terminals may extend from the enclosure to allow electrical coupling of the cell for use in devices, including an anode and cathode terminal. The coupling may be directly connected with a load that may utilize the power, and in some examples the battery cell may be coupled with a control module that may monitor and control charging and discharging of the battery cell. When multiple cells are stacked together, electrode terminals at anode potential may be coupled together, as may be electrode terminals at cathode potential. These coupled terminals may then be connected with the terminals on the enclosure as noted above.

The structure of battery cell 100 may also illustrate the structure of a solid-state battery cell, which may include anode and cathode materials as well as current collectors as noted previously. A difference between the solid-state design and liquid-electrolyte design previously explained is that in addition to not including electrolyte, separator 110 may be characterized by different materials, although the materials may be characterized by similar properties, such as the ability to pass ions through the material while limiting the passage of electrons. In solid-state configurations, the anode and cathode materials may be any of the materials noted above, as well as additional materials operable as electrode active materials within a solid-state cell. For example, anode materials may include graphene or carbon materials, lithium metal, titanium-containing materials, lithium alloys, as well as other anode-compatible materials. Cathode materials may include lithium-containing oxides or phosphates, as well as other cathode-compatible materials. The inter-electrode material, which may also be noted as 110, may include an electron-blocking material, such as a separator, as well as or alternatively, a solid electrolyte material having ion mobility. Glass materials and ceramics may be used, as well as polymeric materials that may include ion-conducting additives, such as lithium salts. In any instance where the word separator is used, it is to be understood as encompassing both separators and solid electrolytes, which may or may not incorporate separator materials. FIG. 1 is included as an exemplary cell that may be incorporated in batteries according to the present technology. It is to be understood, however, that any number of battery and battery cell designs and materials that may include charging and discharging capabilities similarly may be encompassed by or incorporated with the present technology.

FIG. 2 shows a perspective view of a battery 200 into which may be incorporated battery cells formed using an improved embedded electrode formation process, according to at least one example. The battery 200 may include an enclosure 202 that is configured to house a battery cell such as the battery cell 100 described herein and electrolyte material. The battery 200 may also include a pair of electrode terminals 204. The pair of electrode terminals 204 may be electrically connected to the battery cell 100. For example, the electrode tab 204(1) may be connected to the anode electrodes and the electrode tab 204(2) may be cathode electrodes. The arrangement may also be reversed. The pair of electrode terminals 204 may extend from within an internal volume of the enclosure 202 to a location outside of the enclosure 202. For example, the pair of electrode terminals 204 may extend through the enclosure 202 at a seam formed in a first side of the enclosure 202. The enclosure 202 itself may be hermetically sealed to prevent leakage of the electrolyte material, gases, and the like that are present within the enclosure 202 and to prevent intrusion of air or liquid contaminants into the enclosure 202.

The enclosure 202 may be a pouch formed from a composite material such as a thin aluminum sheet sandwiched between two polymer layers. The composite material may be generally pliable and can be wrapped around the battery cell 100 and sealed at the seam 206 using conventional methods.

The enclosure 202 may also be a can formed from a single type of rigid material such as stainless steel or aluminum. The can may include a single part that is sealed at a seam after installation of the battery cell 100, or may be formed from multiple pieces (e.g., a bottom and a lid). The enclosure 202, when formed as the can, may be extruded, pressed, or otherwise formed from a rigid material.

The enclosure 202 may have any uniform or non-uniform shape, including rectangular, cylindrical, spherical, and the like. In some examples, the enclosure 202 may have multiple parts extending in different directions, e.g., a conformal enclosure 202 that includes a first part extending in a first direction and a second part connected to the first part and extending about orthogonally with respect to the first part.

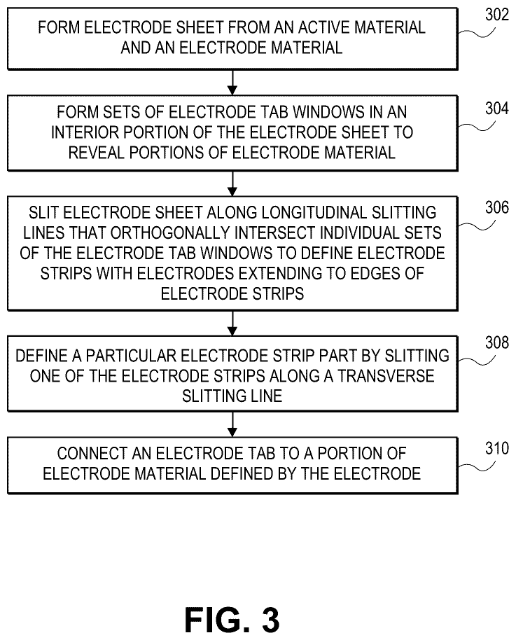

FIG. 3 shows a flowchart illustrating a process 300 for improved embedded electrode formation, according to at least one example. The process 300 will be described with respect to the remaining figures. The process 300 may be performed by a battery cell manufacturer using suitable manufacturing equipment. In some examples, at least some of the process 300 may be performed by a first entity and other part(s) may be performed by other entities.

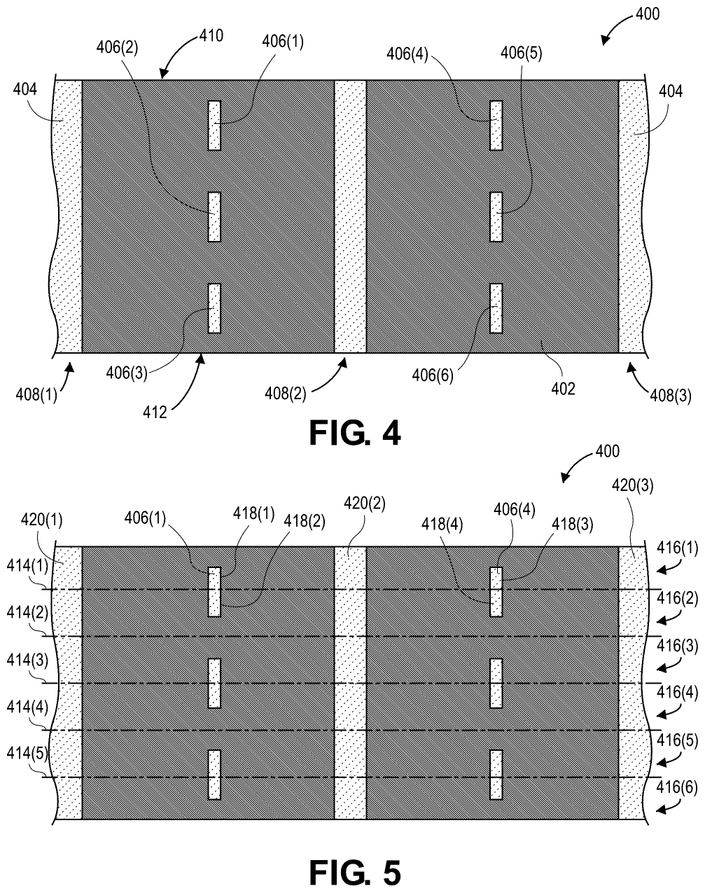

The process 300 begins at block 302 by forming an electrode sheet from an active material and an electrode material. This may include depositing, laying, or otherwise applying a layer of active material on a layer of electrode material or vice versa. FIG. 4 shows a schematic view of an electrode sheet 400 that may be formed by block 302, according to at least one example. The electrode sheet 400 may be suitable for forming a cathode electrode or an anode electrode. Thus, the electrode sheet 400 may be referred to as a jumbo electrode roll because, as described further herein, the electrode sheet 400 may be cut into additional electrode rolls to define six electrode rolls.

The electrode sheet 400 includes an active material layer 402 and an electrode material layer 404. In the illustrated example, the active material layer 402 has been disposed along a top surface of the electrode material layer 404. The active material layer 402 is an example of the active materials 106 and 108. The electrode material layer 404 is an example of the current collectors 102 and 104.

The process 300 continues at block 304 by forming sets of electrode tab windows 406 in an interior portion of the electrode sheet 400 to reveal portions of electrode material 404. The electrode tab windows 406 may represent electrode tab regions, e.g., areas in the electrode sheet 400 where electrodes may be formed in the future. Block 304 may be performed in any suitable manner, which, in some examples, may include etching, patterning, or otherwise defining the electrode tab windows 406 within the electrode sheet 400. Thus, in some examples, block 304 may include removing active material 402 to reveal the electrode material 404 in the electrode tab windows 406.

The electrode tab windows 406 may be laid out in the electrode sheet 400 to define a repeating pattern, both lengthwise and widthwise. The electrode tab windows 406(1) and 406(5) may be spaced apart from a first edge 410 of the electrode sheet 400. In this example, spaced apart may mean that a portion of active material 402 is present between perimeters of the electrode tab windows 406(1) and 406(5) and the first edge 410. As illustrated, the electrode tab windows 406(3) and 406(6) may be spaced apart from a second edge 412 of the electrode sheet 400. The spacing between the second edge 412 and the electrode tab windows 406(3) and 403(6) may be similar to the spacing between the first edge 410 and the electrode tab windows 406(1) and 406(4). As additionally illustrated, the electrode tab windows 406(2) and 406(5) may be spaced respectively between the electrode tab windows 406(1) and 406(3), and the electrode tab windows 406(4) and 406(6). In some examples, the relationship between the distribution of the electrode tab windows 406(1), 406(2), and 406(3) may define a repeating pattern of electrode tab windows in a widthwise direction. In some examples, the relationship between distribution of electrode tab windows 406(1) and 406(4) may define a repeating pattern of electrode tab windows in a lengthwise direction.

As part of block 304 or otherwise, electrode edges 408 may be formed. As illustrated in FIG. 4, the electrode edges 408 may be defined on either side of the area that includes the electrode tab windows 406. As illustrated in later figures, the electrode edges 408 may also be trimmed to define electrode layers that can be stacked or rolled to define electrode cells.

The process 300 continues at block 306 by slitting the electrode sheet 400 along longitudinal slitting lines 414 that orthogonally intersect individual sets of the electrode tab windows 406 to define electrode strips 416 with electrodes 418 extending to edges of the electrode strips 416. FIG. 5 shows a schematic view of the electrode sheet 400 depicting the longitudinal slitting lines 414 (e.g., slitting lines) that define the electrode strips 416, in accordance with at least one example. In the example illustrated in FIG. 5, five longitudinal slitting lines 414 are depicted that define six electrode strips 416. In some examples, each electrode strip 416, which is bounded by at least one longitudinal slitting line 414, may define an electrode lane. Each longitudinal slitting line 414, depicted by a dashed line extending lengthwise across the electrode sheet 400, represents a path of a cutting machine for cutting the electrode sheet 400. Any suitable cutting machine may be used to make the cuts along the longitudinal slitting lines 414. For example, an example cutting machine may include an upper blade and a lower blade that work together to cut through the electrode sheet 400. As an additional example, a laser or other electrical device may be used to cut through the electrode sheet 400. In some examples, the cutting machine may include multiple cutting implements used to slit the electrode sheet along more than one of the longitudinal slitting lines 414 at the same time. For example, all cuts along the longitudinal slitting lines 414(1)-414(5) may be performed in parallel, or may be one or more cuts along the longitudinal slitting lines 414(1)-414(5) may be performed in series.

Each longitudinal slitting line 414 orthogonally intersects one or more electrode tab windows 406. For example, the longitudinal slitting line 414(1) extends lengthwise across the electrode sheet 400 and divides the electrode tab window 406(1) into two about equal electrodes 418(1) and 418(2), and the electrode tab window 406(6) into two about equal electrodes 418(3) and 418(4). The electrodes 418(1) and 418(2) are symmetrical and essentially mirrored copies of each other. This is because the longitudinal slitting line 414(1) extends orthogonally across the electrode tab window 406(1) and split the electrode tab window 406(1) into two equal and symmetrical parts. Each longitudinal slitting line 414 similarly creates symmetrical electrode strips 416 including symmetrical electrodes 418 and other parts.

The longitudinal slitting lines 414(3) and 414(5) similarly equally and symmetrically divide other electrode tab windows 406. The longitudinal slitting lines 414(2) and 414(4) do not intersect electrode tab windows 406. Unlike conventional approaches, the slitting performed at block 306 and which intersects the electrode tab windows 406 enables the electrode tab windows to be ready for tab welding without having to debur, cutaway grooves, or perform other cleaning steps.

The electrode edges 408 are also intersected by the longitudinal slitting lines 414 to define electrode edge parts 420. For example, the longitudinal slitting line 414(1) intersects the electrode edges 408(1), 408(2), and 408(3) to define electrode edge parts 420(1) formed from the electrode edge 408(1), electrode edge part 420(2) formed from the electrode edge 408(2), and electrode edge part 420(3) formed from the electrode edge 408(3). Similar electrode edge parts 420 may be defined by the slitting along the longitudinal slitting lines 414, as illustrated in FIG. 5.

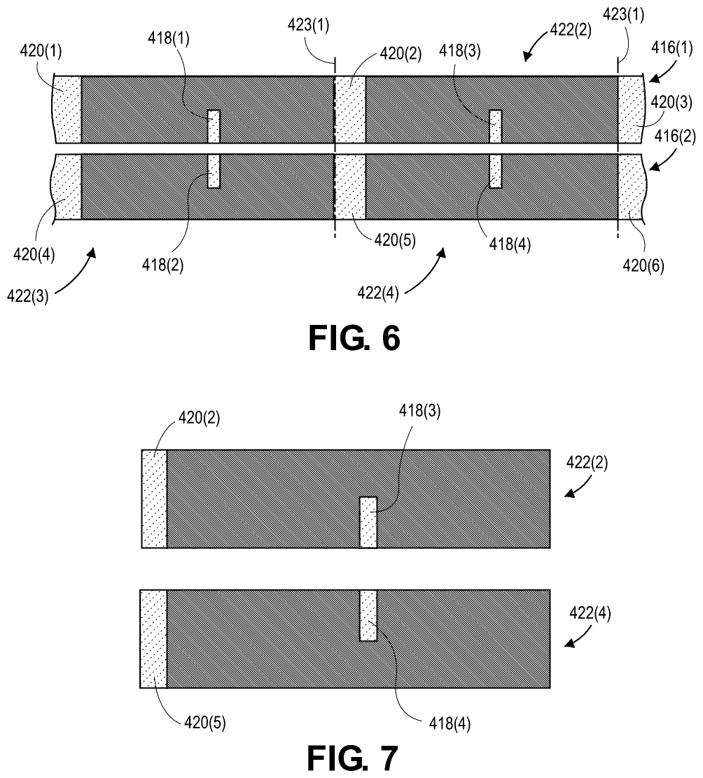

FIG. 6 shows a schematic view of a few electrode strips 416(1) and 416(2) after being slit along longitudinal slitting lines 414(1) and 414(2), according to at least one example. The remaining electrode strips 416(3)-416(6) are omitted for illustrative purposes. FIG. 6 in particular illustrates the electrodes 418(1) and 418(3) and the electrode edge parts 420(1), 420(2), and 420(3) being part of the electrode strip 416(1) and the electrodes 418(2) and 418(4) and the electrode edge parts 420(4), 420(5), and 420(6) being part of the electrode strip 416(2). The electrode strips 416 may be defined as being a part of the electrode sheet 400, but less than the electrode sheet 400.

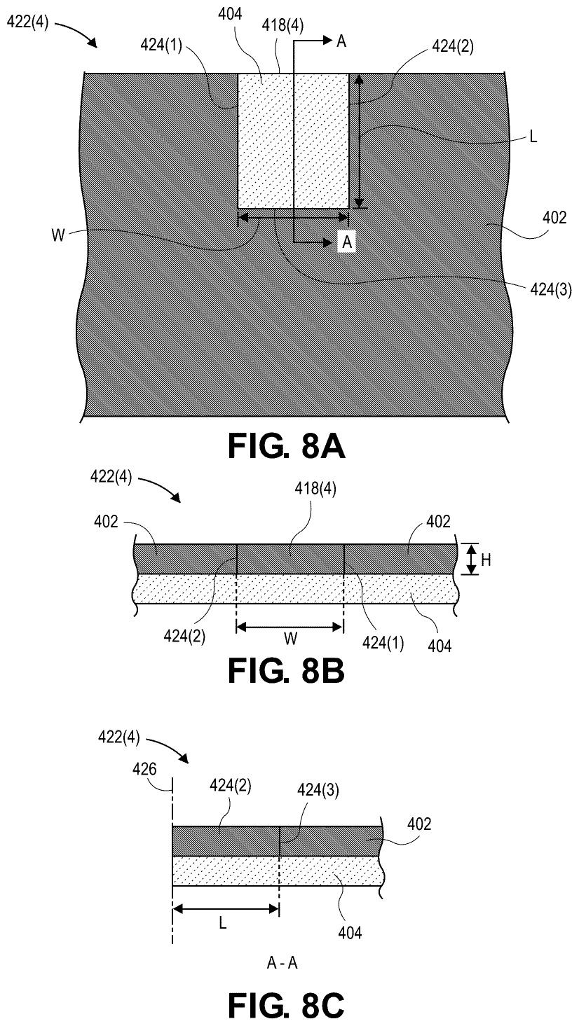

The process 300 continues at block 308 by defining a particular electrode strip part 422 by slitting one of the electrode strips 416 along a transverse slitting line 423, according to at least one example. Block 308 is depicted in FIGS. 6 and 7. FIG. 7 shows a schematic view of a few electrode strip parts 422(2) and 422(4) after being slit along the transverse slitting lines 423(1) and 424(2), according to at least one example. The remaining electrode strip parts 422 from other figures are omitted in FIG. 7 for illustrative purposes. As depicted in FIG. 7, the electrode strip part 422(2) includes the electrode 418(3) formed from the electrode tab window 406(4) and the electrode edge part 420(2) formed from the electrode edge 408(1). Similarly, the electrode strip part 422(4) includes the electrode 418(4) formed from the electrode tab window 406(4) and the electrode edge part 420(5) formed from the electrode edge 408(1). The electrode strip part 422(2) may be a mirrored duplicate of the electrode strip part 422(4). Additional details about the electrodes 418(4) in the electrode strip part 422(4) are shown and described with respect to FIGS. 8A, 8B, and 8C.

FIG. 8A shows a schematic top view of the electrode strip part 422(4) zoomed in on the electrode 418(4), according to at least one example. FIG. 8B shows a schematic side view the electrode strip part 422(4) and the electrode 418(4) from FIG. 8A, according to at least one example. FIG. 8C shows a schematic cross-sectional view of the electrode strip part 422(4) and the electrode 418(4) from FIG. 8A taken at section A-A, according to at least one example. The electrode 418(4) may be defined as having a three-dimensional shape that corresponds to a void volume defined by a height (H) corresponding to the thickness of the active material 402, a width (W) extending between edges 424(1) and 424(2) of the active material 402 surrounding the electrode 418(4), and a length (L) extending from an edge 424(3) of the active material 402 and an end plane 426. The end plane 426 may extend orthogonally to a planar surface of the electrode strip part 422(4), visible in FIG. 8A. As described herein, because the longitudinal slitting lines intersect the electrode tab windows 406, the active material 402 is held back from the end plane 426 so as to define the electrodes 418 (e.g., the electrode 418(4)) as extending directly to the end plane 426. Conventional slitting approaches, on the other hand, include longitudinal slitting lines that do not intersect orthogonally across electrode tab windows. Therefore, additionally processing in the form of groove cutting needs to be performed after slitting. Unlike the electrode 418(4) that includes electrode material 404 that extends all the way to the end plane 426, in conventional electrode arrangements, the electrode material 402 is cut back away from the end plane 426 as part of the groove cutting operation that cuts the electrode material 402 and a small amount of active material 402.

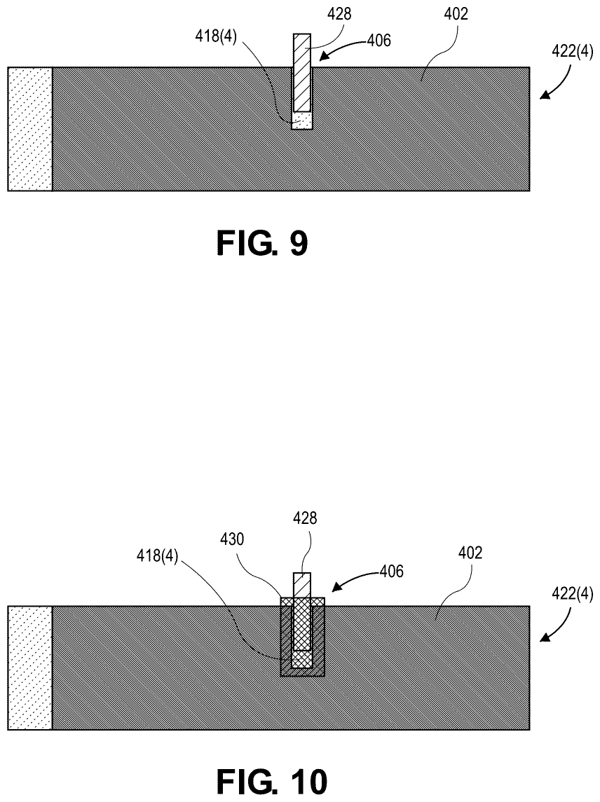

Returning to the process 300 of FIG. 3, at block 310, the process 300 includes connecting an electrode tab 428 to a portion of the electrode material 404 defined by the electrode 418. FIG. 9 shows a schematic view of the electrode strip part 422(4) including the electrode tab 428 disposed within the portion of the electrode tab window 406 that defines the electrode 418, according to at least one example. In some examples, the electrode tab 428 may include a conductive material and may be welded or otherwise electrically connected to the electrode 418. In some examples, connecting of block 310 may also include applying a tape 430 or other adhesive to the electrode 418 and a portion of the active material 402 surrounding the electrode 418. FIG. 10 shows a schematic view of the electrode strip part 422(4) including the tape 430 covering a portion of the electrode 418, according to at least one example. In some examples, after the electrode 418 has been formed as described above, the electrode tab 428 and the tape 430 may be applied without any additional processing operations. This is because the distal edge of the electrode 408 is planar and void of the active material 402.

In the following, further clauses are described to facilitate the understanding of the present disclosure.
Clause 1. A manufacturing method, comprising:
   forming an electrode sheet comprising an electrode material and an active material, wherein a first plurality of electrode tab windows is defined in the active material to expose first portions of the electrode material; and
   slitting the electrode sheet along a first line that orthogonally intersects the first plurality of electrode tab windows to define a first electrode strip comprising a first set of electrodes and a second electrode strip comprising a second set of electrodes.
Clause 2. The manufacturing method of clause 1, further comprising physically and electrically connecting a first set of electrode tabs to active material within the first set of electrodes.
Clause 3. The manufacturing method of clause 2, wherein physically and electrically connecting the first set of electrode tabs to the active material within the first set of electrodes is performed directly following slitting the electrode sheet.
Clause 4. The manufacturing method of clause 2, further comprising applying portions of tape to cover the first set of electrodes and portions of the first set of electrode tabs disposed within the first set of electrodes.
Clause 5. The manufacturing method of clause 1, wherein quantities of the first plurality of electrode tab windows, the first set of electrodes, and the second set of electrodes are equal.
Clause 6. The manufacturing method of clause 1, wherein a plurality of electrode lanes is defined on the electrode sheet, and wherein the first plurality of tab windows extends between two electrode lanes of the plurality of electrode lanes.
Clause 7. The manufacturing method of clause 6, wherein the first line defines a boundary between the two electrode lanes.
Clause 8. The manufacturing method of clause 6, wherein the plurality of electrode lanes is distributed transversally across a first dimension of the electrode sheet and extend longitudinally along a second dimension of the electrode sheet.
Clause 9. The manufacturing method of clause 6, wherein a second plurality of tab windows is defined in the active material to expose second portions of the electrode material, and wherein the method further comprises slitting the electrode sheet along a second line that orthogonally intersects the second plurality of tab windows to define a third electrode strip comprising a third set of electrodes and a fourth electrode strip comprising a fourth set of electrodes.
Clause 10. The manufacturing method of clause 1, wherein the electrode sheet is defined by a first edge and a second edge opposite the first edge, and wherein the first portions of the electrode material are offset from the first edge and the second edge.
Clause 11. The manufacturing method of clause 10, wherein the first electrode strip is defined by the first edge of the electrode sheet and a third edge opposite the first edge, and wherein the second electrode strip is defined by the second edge of the electrode sheet and a fourth edge opposite the second edge.
Clause 12. The manufacturing method of clause 11, wherein the first set of electrodes of the first electrode strip is defined at the third edge of the first electrode strip, and wherein the second set of electrodes of the second electrode strip is defined at the fourth edge of the second electrode strip.
Clause 13. An electrode, comprising:
   an electrode sheet comprising a first edge and a second edge, wherein the electrode sheet is formed from an electrode material and an active material; and
   an electrode defined in the active material to expose a portion of the electrode material, wherein the electrode extends from the first edge towards the second edge, and wherein the portion of the electrode material extends across the electrode to the first edge.
Clause 14. The electrode of clause 13, further comprising an electrode tab that is physically and electrically connected to the portion of the electrode material that defines the electrode.
Clause 15. The electrode of clause 14, further comprising a tape that covers the portion of the electrode material that defines the electrode and a portion of the electrode tab that is disposed on the electrode.
Clause 16. The electrode of clause 13, wherein the electrode sheet comprises a single jumbo roll electrode.
Clause 17. The electrode of clause 13, the active material is disposed along a first surface of the electrode material.
Clause 18. The electrode of clause 13, wherein a first plane is defined at the first edge and extends orthogonally with respect to the electrode sheet, and wherein the portion of the electrode material that defines the electrode terminates at the first plane.
Clause 19. A battery cell, comprising:
   a first electrode comprising:
      a first tab window defined in a first active material layer of the first electrode at a first edge of the first electrode to reveal a portion of a first electrode material layer of the first electrode that extends to the first edge; and
      a first tab electrically and physically connected to the portion of the first electrode material layer exposed within the first tab window; and
   a second electrode comprising:
      a second tab window defined in a second active material layer of the second electrode at a second edge of the second electrode to reveal a portion of a second electrode material layer of the second electrode that extends to the second edge; and
      a second tab electrically and physically connected to the portion of the second electrode material layer exposed within the second tab window.
Clause 20. The battery cell of clause 19, wherein the first electrode is a cathode and the second electrode is an anode.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A manufacturing method, comprising:
forming an electrode sheet comprising an electrode material and an active material, wherein a first plurality of electrode tab windows is defined in the active material to expose first portions of the electrode material; and
slitting the electrode sheet along a first line that orthogonally intersects the first plurality of electrode tab windows to define a first electrode strip comprising a first set of electrodes and a second electrode strip comprising a second set of electrodes.

2. The manufacturing method of claim 1, further comprising physically and electrically connecting a first set of electrode tabs to active material within the first set of electrodes.

3. The manufacturing method of claim 2, wherein physically and electrically connecting the first set of electrode tabs to the active material within the first set of electrodes is performed directly following slitting the electrode sheet.

4. The manufacturing method of claim 2, further comprising applying portions of tape to cover the first set of electrodes and portions of the first set of electrode tabs disposed within the first set of electrodes.

5. The manufacturing method of claim 1, wherein quantities of the first plurality of electrode tab windows, the first set of electrodes, and the second set of electrodes are equal.

6. The manufacturing method of claim 1, wherein a plurality of electrode lanes is defined on the electrode sheet, and wherein the first plurality of tab windows extends between two electrode lanes of the plurality of electrode lanes.

7. The manufacturing method of claim 6, wherein the first line defines a boundary between the two electrode lanes.

8. The manufacturing method of claim 6, wherein the plurality of electrode lanes is distributed transversally across a first dimension of the electrode sheet and extend longitudinally along a second dimension of the electrode sheet.

9. The manufacturing method of claim 6, wherein a second plurality of tab windows is defined in the active material to expose second portions of the electrode material, and wherein the method further comprises slitting the electrode sheet along a second line that orthogonally intersects the second plurality of tab windows to define a third electrode strip comprising a third set of electrodes and a fourth electrode strip comprising a fourth set of electrodes.

10. The manufacturing method of claim 1, wherein the electrode sheet is defined by a first edge and a second edge opposite the first edge, and wherein the first portions of the electrode material are offset from the first edge and the second edge.

11. The manufacturing method of claim 10, wherein the first electrode strip is defined by the first edge of the electrode sheet and a third edge opposite the first edge, and wherein the second electrode strip is defined by the second edge of the electrode sheet and a fourth edge opposite the second edge.

12. The manufacturing method of claim 11, wherein the first set of electrodes of the first electrode strip is defined at the third edge of the first electrode strip, and wherein the second set of electrodes of the second electrode strip is defined at the fourth edge of the second electrode strip.

13. An electrode, comprising:
an electrode sheet comprising a first edge and a second edge, wherein the electrode sheet is formed from an electrode material and an active material; and
an electrode defined in the active material to expose a portion of the electrode material, wherein the electrode extends from the first edge towards the second edge, and wherein the portion of the electrode material extends across the electrode to the first edge.

14. The electrode of claim 13, further comprising an electrode tab that is physically and electrically connected to the portion of the electrode material that defines the electrode.

15. The electrode of claim 14, further comprising a tape that covers the portion of the electrode material that defines the electrode and a portion of the electrode tab that is disposed on the electrode.

16. The electrode of claim 13, wherein the electrode sheet comprises a single jumbo roll electrode.

17. The electrode of claim 13, the active material is disposed along a first surface of the electrode material.

18. The electrode of claim 13, wherein a first plane is defined at the first edge and extends orthogonally with respect to the electrode sheet, and wherein the portion of the electrode material that defines the electrode terminates at the first plane.

19. A battery cell, comprising:
a first electrode comprising:
a first tab window defined in a first active material layer of the first electrode at a first edge of the first electrode to reveal a portion of a first electrode material layer of the first electrode that extends to the first edge; and
a first tab electrically and physically connected to the portion of the first electrode material layer exposed within the first tab window; and
a second electrode comprising:
a second tab window defined in a second active material layer of the second electrode at a second edge of the second electrode to reveal a portion of a second electrode material layer of the second electrode that extends to the second edge; and
a second tab electrically and physically connected to the portion of the second electrode material layer exposed within the second tab window.

20. The battery cell of claim 19, wherein the first electrode is a cathode and the second electrode is an anode.
